(19) United States
(12) Patent Application Publication
(10) Pub. No.: US 2023/0341872 A1
(43) Pub. Date: Oct. 26, 2023

(54) MANAGEMENT SYSTEM OF WORK SITE AND MANAGEMENT METHOD OF WORK SITE

(71) Applicants: Komatsu Ltd., Tokyo (JP); Toyota Jidosha Kabushiki Kaisha, Toyota-shi (JP)

(72) Inventors: Takashi Hiranaka, Tokyo (JP); Shota Konishi, Tokyo (JP); Shun Maruyama, Numazu-shi (JP); Takahiro Okano, Chiryu-shi (JP); Toru Takashima, Susono-shi (JP); Shun Mizoo, Zama-shi (JP)

(73) Assignees: Komatsu Ltd., Tokyo (JP); Toyota Jidosha Kabushiki Kaisha, Toyota-shi (JP)

(21) Appl. No.: 18/304,011

(22) Filed: Apr. 20, 2023

(30) Foreign Application Priority Data
Apr. 22, 2022 (JP) 2022-070689

(51) Int. Cl. G05D 1/02

(52) U.S. Cl. CPC G05D 1/0291; G05D 2201/0202

(57) ABSTRACT

A management system of a work site includes: a priority storage unit that stores priority related to traveling continuation of an unmanned vehicle traveling in the work site; an input signal acquisition unit that acquires an input signal related to traveling stop of the unmanned vehicle; a decision unit that decides the traveling continuation or the traveling stop for each of a plurality of the unmanned vehicles traveling in the work site based on the priority and the input signal; and an output unit that outputs a traveling stop command to the unmanned vehicle for which the traveling stop is decided.

### CROSS-REFERENCE TO RELATED APPLICATION(S)

The present application claims priority to and incorporates by reference the entire contents of Japanese Patent Application No. 2022-070689 filed in Japan on Apr. 22, 2022.

### BACKGROUND OF THE INVENTION

### 1. Field of the Invention

The present disclosure relates to a management system of a work site and a management method of a work site.

### 2. Description of the Related Art

In a technical field related to a management system of a work site, a mining machine operation management system as disclosed in Japanese Laid-open Patent Application No. 2017-117328 is known.

In a work site, a plurality of unmanned vehicles travels simultaneously. If an accident occurs in the work site, there are cases where it is preferable to cause all unmanned vehicles to stop traveling, and there are cases where it is preferable to cause some unmanned vehicles to continue traveling.

An object of the present disclosure is to properly decide traveling stop and traveling continuation of unmanned vehicles.

### SUMMARY OF THE INVENTION

It is an object of the present invention to at least partially solve the problems in the conventional technology.

According to an aspect of the present invention, a management system of a work site, the management system comprises: a priority storage unit that stores priority related to traveling continuation of an unmanned vehicle traveling in the work site; an input signal acquisition unit that acquires an input signal related to traveling stop of the unmanned vehicle; a decision unit that decides the traveling continuation or the traveling stop for each of a plurality of the unmanned vehicles traveling in the work site based on the priority and the input signal; and an output unit that outputs a traveling stop command to the unmanned vehicle for which the traveling stop is decided.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram illustrating a work site according to an embodiment;

FIG. 2 is a schematic diagram illustrating a management system of the work site according to the embodiment;

FIG. 3 is a block diagram illustrating the management system of the work site according to the embodiment;

FIG. 4 is a diagram illustrating a relationship between priority and input signals according to the embodiment;

FIG. 5 is a diagram illustrating a relationship between priority and types and states of unmanned vehicles according to the embodiment; and

FIG. 6 is a flowchart illustrating a management method of the work site according to the embodiment.

### DETAILED DESCRIPTION OF THE PREFERRED EMBODIMENTS

Embodiments according to the present disclosure will be described below with reference to the drawings, but the present disclosure is not limited to the embodiments. Components of the embodiment described below can be combined as appropriate. Some components may not be used in some cases.

Work Site

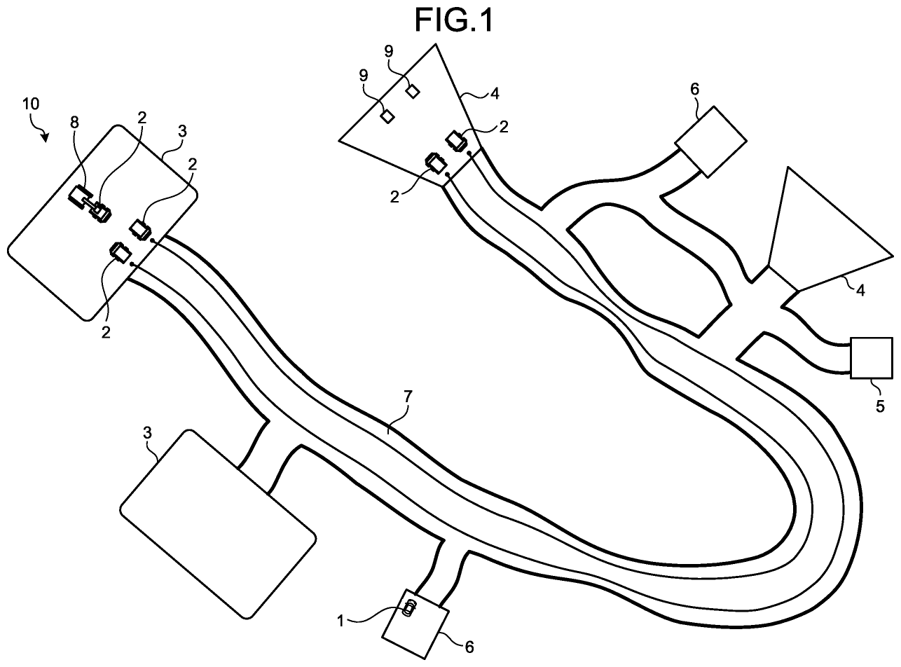

FIG. 1 is a schematic diagram illustrating a work site 10 according to the embodiment. As the work site 10, a mine or a quarry is exemplified. The mine refers to a place or establishment from which minerals are extracted. The quarry refers to a place or establishment from which stones are extracted. As the mine, metal mines for mining metals, non-metal mines for mining limestone, or coal mines for mining coal are exemplified.

In the work site 10, a first unmanned vehicle 1 and a second unmanned vehicle 2 operate. The unmanned vehicle refers to a vehicle that operates in an unmanned manner without being operated by a driver. The first unmanned vehicle 1 and the second unmanned vehicle 2 may or may not be work vehicles that perform predetermined work.

In the embodiment, the first unmanned vehicle 1 is a light vehicle that travels in the work site 10 in an unmanned manner. In the embodiment, the first unmanned vehicle 1 is appropriately referred to as an unmanned light vehicle 1.

In the embodiment, the second unmanned vehicle 2 is a heavy vehicle that travels in the work site 10 in an unmanned manner. In the embodiment, the second unmanned vehicle 2 is a work vehicle. The second unmanned vehicle 2 is a haul vehicle that performs haul work of hauling a cargo. In the embodiment, the second unmanned vehicle 2 is appropriately referred to as an unmanned dump truck 2.

The work site 10 includes a loading area 3, a sand-dumping area 4, a parking area 5, a standby area 6, and a runway 7.

The loading area 3 refers to an area where loading work of loading a cargo to the unmanned dump truck 2 is performed. As the cargo, an excavated material excavated in the loading area 3 is exemplified. In the loading area 3, a loader 8 operates. As the loader 8, an excavator is exemplified.

The sand-dumping area 4 refers to an area where sand-dumping work of dumping a cargo from the unmanned dump truck 2 is performed. A crusher 9 is provided in the sand-dumping area 4.

The parking area 5 refers to an area where the unmanned dump truck 2 is parked.

The standby area 6 refers to an area where the unmanned light vehicle 1 stands by.

The runway 7 refers to an area where at least one of the unmanned light vehicle 1 and the unmanned dump truck 2 travels. The runway 7 is provided to connect at least the loading area 3 to the sand-dumping area 4. In the embodiment, the runway 7 is connected to each of the loading area 3, the sand-dumping area 4, the parking area 5, and the standby area 6.

The unmanned light vehicle 1 can travel in each of the loading area 3, the sand-dumping area 4, the standby area 6, and the runway 7. The unmanned dump truck 2 can travel in each of the loading area 3, the sand-dumping area 4, the parking area 5, and the runway 7. The unmanned dump truck 2 travels in the runway 7, for example, to go back and forth between the loading area 3 and the sand-dumping area 4.

Management System

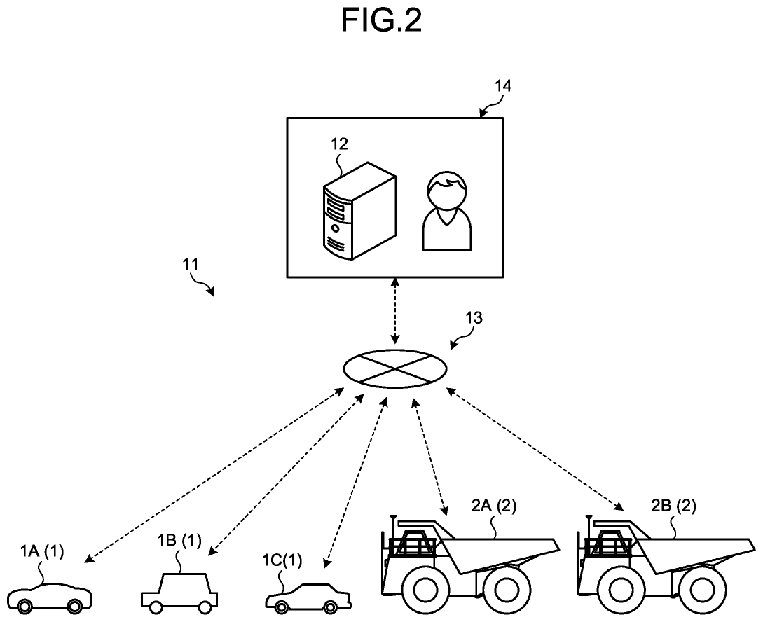

FIG. 2 is a schematic diagram illustrating a management system 11 of the work site 10 according to the embodiment. The management system 11 includes a management device 12 and a communication system 13. The management device 12 is disposed outside the unmanned light vehicle 1 and the unmanned dump truck 2. The management device 12 is installed in a control facility 14 of the work site 10. The management device 12 includes a computer system. As the communication system 13, the Internet, a mobile phone network, a satellite communication network, or a local area network (LAN) is exemplified.

The plurality of unmanned light vehicles 1 operates in the work site 10. The plurality of unmanned dump trucks 2 operates in the work site 10. As one example, FIG. 2 illustrates a first unmanned light vehicle 1A, a second unmanned light vehicle 1B, and a third unmanned light vehicle 1C as the unmanned light vehicle 1. As one example, FIG. 2 illustrates a first unmanned dump truck 2A and a second unmanned dump truck 2B as the unmanned dump truck 2.

The type of the first unmanned light vehicle 1A, the type of the second unmanned light vehicle 1B, and the type of the third unmanned light vehicle 1C are different from each other. The number of first unmanned light vehicles 1A operating in the work site 10 may be one, or two or more. The number of second unmanned light vehicles 1B operating in the work site 10 may be one, or two or more. The number of third unmanned light vehicles 1C operating in the work site 10 may be one, or two or more. The type of the unmanned light vehicle 1 is not limited to three types, and may be one type, two types, or four or more types.

The type of the first unmanned dump truck 2A is different from the type of the second unmanned dump truck 2B. The number of first unmanned dump trucks 2A operating in the work site 10 may be one, or two or more. The number of second unmanned dump trucks 2B operating in the work site 10 may be one, or two or more. The type of the unmanned dump truck 2 is not limited to two types, and may be one type or three or more types.

In the following description, the unmanned light vehicle 1 and the unmanned dump truck 2 are collectively referred to as an unmanned vehicle 100 as appropriate. Note that the unmanned vehicle 100 operating in the work site 10 is not limited to the unmanned light vehicle 1 and the unmanned dump truck 2. The unmanned vehicle 100 may include a work vehicle such as a sprinkler vehicle or a loading vehicle. Each of the plurality of unmanned vehicles 100 can travel in the work site 10.

The management device 12 can wirelessly communicate with each of the plurality of unmanned vehicles 100 via the communication system 13.

In the embodiment, the management device 12 transmits travel data indicating travel conditions to each of the plurality of unmanned vehicles 100. The unmanned vehicle 100 travels in the work site 10 based on the travel data transmitted from the management device 12. The travel data includes a travel path indicating a target travel route of the unmanned vehicle 100 and a target travel speed of the unmanned vehicle 100 when traveling in the travel path. The unmanned vehicle 100 travels according to the travel path. Note that the unmanned vehicle 100 may travel in the work site 10 without using the travel path. The unmanned vehicle 100 may travel in the work site 10, for example, based on map data of the work site 10. When the unmanned vehicle 100 is provided with a positional sensor that detects the position of the unmanned vehicle 100, the unmanned vehicle 100 can travel in the work site 10 while checking the position of the vehicle based on detection data of the positional sensor. As the positional sensor, a global navigation satellite system (GNSS) receiver that detects the position of the unmanned vehicle 100 by using the GNSS is exemplified.

The management device 12 can transmit a traveling start command and a traveling stop command to each of the plurality of unmanned vehicles 100. The unmanned vehicle 100 starts traveling on receipt of the traveling start command in the traveling stop state. The unmanned vehicle 100 stops traveling on receipt of the traveling stop command in the traveling state. The unmanned vehicle 100 continues traveling on receipt of no traveling stop command in the traveling state.

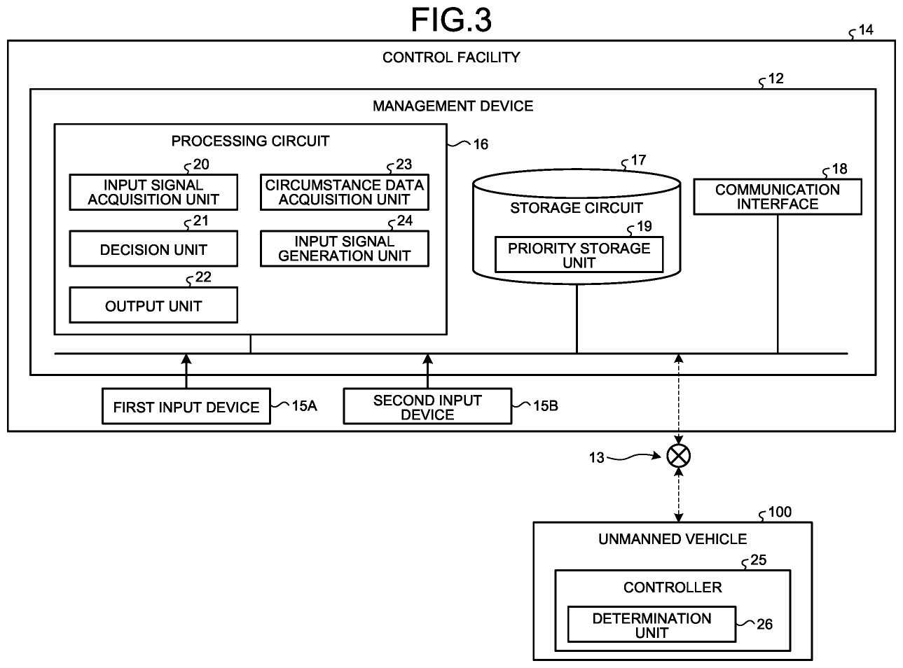

FIG. 3 is a block diagram illustrating the management system 11 of the work site 10 according to the embodiment.

The management device 12 includes a computer system. The management device 12 includes a processing circuit 16, a storage circuit 17, and a communication interface 18.

The unmanned vehicle 100 includes a controller 25. The controller 25 includes a computer system.

The processing circuit 16 performs arithmetic processing and output processing of control commands. As the processing circuit 16, a processor is exemplified. As the processor, a central processing unit (CPU) or micro processing unit (MPU) is exemplified. A computer program is stored in the storage circuit 17. The processing circuit 16 acquires and executes the computer program from the storage circuit 17, thereby performing a predetermined function.

The storage circuit 17 is connected to the processing circuit 16. The storage circuit 17 stores data. As the storage circuit 17, a non-volatile memory or a volatile memory is exemplified. As the non-volatile memory, a read only memory (ROM) or a storage is exemplified. As the storage, a hard disk drive (HDD) or a solid state drive (SSD) is exemplified. As the volatile memory, a random access memory (RAM) is exemplified.

The communication interface 18 is connected to the processing circuit 16. The communication interface 18 controls communication between the management device 12 and the controller 25 of the unmanned vehicle 100. The communication interface 18 communicates with the controller 25 of the unmanned vehicle 100 via the communication system 13.

A first input device 15A and a second input device 15B are connected to the management device 12. Each of the first input device 15A and the second input device 15B is manipulated by an administrator at the control facility 14. As the first input device 15A and the second input device 15B, a computer keyboard, push button, mouse, or touch panel is exemplified.

The storage circuit 17 includes a priority storage unit 19. The processing circuit 16 includes an input signal acquisition unit 20, a decision unit 21, an output unit 22, a circumstance data acquisition unit 23, and an input signal generation unit 24. The controller 25 includes a determination unit 26.

The priority storage unit 19 stores priority related to traveling continuation of the unmanned vehicle 100 traveling in the work site 10. The priority is decided in advance based on at least one of the type of the unmanned vehicle 100 and the state of the unmanned vehicle 100.

The input signal acquisition unit 20 acquires an input signal related to traveling stop of the unmanned vehicle 100. The input signal is generated by manipulating the first input device 15A. The administrator can generate the input signal related to the traveling stop of the unmanned vehicle 100 by manipulating the first input device 15A. The input signal acquisition unit 20 acquires the input signal related to the traveling stop of the unmanned vehicle 100 from the first input device 15A.

The decision unit 21 decides traveling continuation or traveling stop for each of the plurality of unmanned vehicles 100 traveling in the work site 10 based on the priority stored in the priority storage unit 19 and the input signal acquired by the input signal acquisition unit 20.

The priority designates the unmanned vehicle 100 to continue traveling and the unmanned vehicle 100 to stop traveling by the input signal. The decision unit 21 decides traveling continuation or traveling stop for each of the plurality of unmanned vehicles 100 traveling in the work site 10 based on the priority.

The output unit 22 outputs the traveling stop command to the unmanned vehicle 100 for which traveling stop has been decided. The traveling stop command is transmitted to the unmanned vehicle 100 for which traveling stop has been decided via the communication system 13.

The circumstance data acquisition unit 23 acquires circumstance data indicating the circumstance of the work site 10. The circumstance data is acquired by manipulating the second input device 15B. The administrator can input the circumstance data indicating the circumstance of the work site 10 to the management device 12 by manipulating the second input device 15B. The circumstance data acquisition unit 23 acquires the circumstance data indicating the circumstance of the work site 10 from the second input device 15B. Note that if a circumstance sensor that detects the circumstance of the work site 10 is disposed in the work site 10, the circumstance data acquisition unit 23 may acquire the circumstance data from the circumstance sensor.

The circumstance of the work site 10 includes an accident that has occurred in the work site 10. As the type of accident that has occurred in the work site 10, a fire, landslide caused by earthquake, flood caused by heavy rain, heavy snow, vehicle accident, or accident resulting in injury or death is exemplified. The circumstance data includes the type, scale, and location of the accident that has occurred in the work site 10.

The input signal generation unit 24 generates the input signal related to traveling stop of the unmanned vehicle based on the circumstance data. When the circumstance data acquisition unit 23 acquires the circumstance data without the first input device 15A being manipulated, the input signal acquisition unit 20 generates the input signal related to traveling stop of the unmanned vehicle based on the circumstance data. The input signal acquisition unit 20 acquires the input signal generated by the input signal generation unit 24 from the input signal generation unit 24.

The determination unit 26 determines whether to stop traveling by the traveling stop command based on the circumstance of the unmanned vehicle 100. Even on receipt of the traveling stop command from the management device 12, on determination that it is appropriate to cause the unmanned vehicle 100 to continue traveling based on the circumstance of the unmanned vehicle 100, the determination unit 26 determines not to stop traveling. When the determination unit 26 determines not to stop traveling, the unmanned vehicle 100 continues traveling.

The circumstance of the unmanned vehicle 100 includes influence of surroundings of the unmanned vehicle 100. For example, in a case where the unmanned vehicle 100 receives the traveling stop command while traveling on the runway 7 with a narrow road width, if traveling stop is immediately performed based on the traveling stop command, the runway 7 will be blocked, and as a result, there is a possibility that traveling of another unmanned vehicle 100 decided to continue traveling will be interfered. On determination that it is inappropriate to cause the unmanned vehicle 100 to immediately stop traveling based on the traveling stop command, the determination unit 26 determines not to cause the unmanned vehicle 100 to stop traveling. The unmanned vehicle 100 continues traveling, for example, until reaching the runway 7 with a wider road width.

In addition, the circumstance of the unmanned vehicle 100 includes the circumstance of the road surface on which the unmanned vehicle 100 is traveling. For example, in a case where the unmanned vehicle 100 receives the traveling stop command while traveling on a muddy road, if the traveling stop is performed immediately based on the traveling stop command, there is a possibility of getting stuck. On determination that it is inappropriate to cause the unmanned vehicle 100 to immediately stop traveling based on the traveling stop command, the determination unit 26 determines not to cause the unmanned vehicle 100 to stop traveling. The unmanned vehicle 100 continues traveling, for example, until reaching the runway 7 with a dry road surface.

### PRIORITY

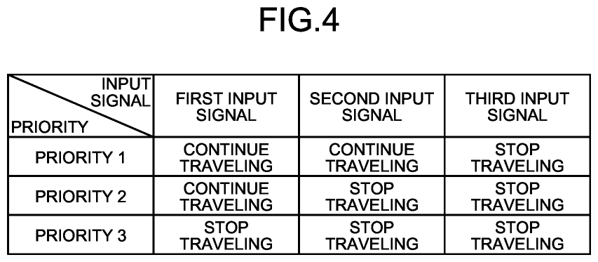

FIG. 4 is a diagram illustrating a relationship between priority and the input signal according to the embodiment. The administrator can generate a plurality of types of input signal by manipulating the first input device 15A. The input signal generated by manipulating the first input device 15A includes at least a first input signal and a second input signal. In the example illustrated in FIG. 4, the input signal includes the first input signal, the second input signal, and a third input signal.

The priority of the unmanned vehicle 100 that stope traveling by the first input signal, the priority of the unmanned vehicle 100 that stops traveling by the second input signal, and the priority of the unmanned vehicle 100 that stops traveling by the third input signal are different from one another.

When the first input device 15A is manipulated and the first input signal is acquired by the input signal acquisition unit 20, the unmanned vehicle 100 that continues traveling is the unmanned vehicle 100 of priority 1 and priority 2, whereas the unmanned vehicle 100 that stops traveling is the unmanned vehicle 100 of priority 3.

When the first input device 15A is manipulated and the second input signal is acquired by the input signal acquisition unit 20, the unmanned vehicle 100 that continues traveling is the unmanned vehicle 100 of priority 1, whereas the unmanned vehicle 100 that stops traveling is the unmanned vehicle 100 of priority 2 and priority 3.

When the first input device 15A is manipulated and the third input signal is acquired by the input signal acquisition unit 20, no unmanned vehicle 100 continues traveling, whereas the unmanned vehicle 100 that stops traveling is the unmanned vehicle 100 of priority 1, priority 2, and priority 3.

First correlation data indicating the relationship between the priority and the input signal as illustrated in FIG. 4 is decided in advance and stored in the priority storage unit 19.

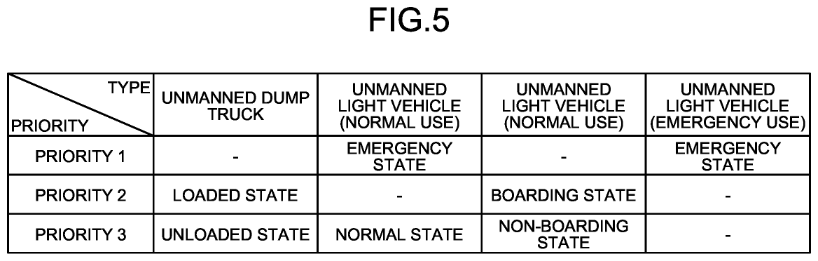

FIG. 5 is a diagram illustrating a relationship between the priority and the type and state of the unmanned vehicle 100 according to the embodiment. The priority related to the traveling continuation of the unmanned vehicle 100 is decided based on at least one of the type and state of the unmanned vehicle 100. The state of the unmanned vehicle 100 includes the traveling state of the unmanned vehicle 100.

FIG. 5 illustrates the case where the type of the unmanned vehicle 100 includes the unmanned dump truck 2, the first unmanned light vehicle 1 used for normal use, the second unmanned light vehicle 1 used for normal use, and the third unmanned light vehicle 1 used for emergency use.

The state of the unmanned dump truck 2 includes a loaded state in which the unmanned dump truck 2 travels with a cargo loaded on the dump body and an unloaded state in which the dump truck travels without a cargo. The unmanned dump truck 2 of the loaded state is the unmanned vehicle 100 of priority 2, whereas the unmanned dump truck 2 of the unloaded state is the unmanned vehicle 100 of priority 3.

The state of the first unmanned light vehicle 1 include an emergency state of traveling for urgent purposes and a normal state of traveling without urgency. The first unmanned light vehicle 1 of the emergency state is the unmanned vehicle 100 of priority 1. The first unmanned light vehicle 1 of the normal state is the unmanned vehicle 100 of priority 3.

The state of the second unmanned light vehicle 1 includes a boarding state in which the vehicle travels with a passenger on board and a non-boarding state in which the vehicle travels without a passenger on board. The second unmanned light vehicle 1 of the boarding state is the unmanned vehicle 100 of priority 2. The second unmanned light vehicle 1 of the non-boarding state is the unmanned vehicle 100 of priority 3.

The state of the third unmanned light vehicle 1 include an emergency state of traveling for urgent purposes. The third unmanned light vehicle 1 of the emergency state is the unmanned vehicle 100 of priority 1.

Second correlation data indicating the relationship between the priority and the type and state of the unmanned vehicle 100 as illustrated in FIG. 5 is decided in advance and stored in the priority storage unit 19.

If an accident occurs in the work site 10, the administrator manipulates the first input device 15A to generate either one of the first input signal, the second input signal, and the third input signal based on the type, scale, and location of the accident that has occurred in the work site 10. In a case where the input signal to be generated based on the type, scale, and location of the accident is decided in advance as a manual, the administrator can manipulate the first input device 15A based on the manual to generate either one of the first input signal, the second input signal, and the third input signal.

When either one of the first input signal, the second input signal, and the third input signal is generated by the first input device 15A and the input signal acquisition unit 20 acquires the input signal generated by the first input device 15A, the decision unit 21 decides to continue or stop traveling for each of the plurality of unmanned vehicles 100 traveling in the work site 10, based on the first correlation data related to the priority and the second correlation data related to the priority stored in the priority storage unit 19 and the input signal acquired by the input signal acquisition unit 20.

When the first input signal is generated, based on the first correlation data and the second correlation data stored in the priority storage unit 19 and the first input signal acquired by the input signal acquisition unit 20, the decision unit 21 decides that the first unmanned light vehicle 1 of the emergency state and the third unmanned light vehicle 1 of the emergency state that are the unmanned vehicle 100 of priority 1 continue traveling, the unmanned dump truck 2 of the loaded state and the second unmanned light vehicle 1 of the boarding state that are the unmanned vehicle 100 of priority 2 continue traveling, and the unmanned dump truck 2 of the unloaded state, the first unmanned light vehicle 1 of the normal state, and the second unmanned light vehicle 1 of the non-boarding state that are the unmanned vehicle 100 of priority 3 stop traveling.

When the second input signal is generated, based on the first correlation data and the second correlation data stored in the priority storage unit 19 and the second input signal acquired by the input signal acquisition unit 20, the decision unit 21 decides that the first unmanned light vehicle 1 of the emergency state and the third unmanned light vehicle 1 of the emergency state that are the unmanned vehicle 100 of priority 1 continue traveling, the unmanned dump truck 2 of the loaded state and the second unmanned light vehicle 1 of the boarding state that are the unmanned vehicle 100 of priority 2 stop traveling, and the unmanned dump truck 2 of the unloaded state, the first unmanned light vehicle 1 of the normal state, and the second unmanned light vehicle 1 of the non-boarding state that are the unmanned vehicle 100 of priority 3 stop traveling.

When the third input signal is generated, based on the first correlation data and the second correlation data stored in the priority storage unit 19 and the third input signal acquired by the input signal acquisition unit 20, the decision unit 21 decides that the first unmanned light vehicle 1 of the emergency state and the third unmanned light vehicle 1 of the emergency state that are the unmanned vehicle 100 of priority 1 stop traveling, the unmanned dump truck 2 of the loaded state and the second unmanned light vehicle 1 of the boarding state that are the unmanned vehicle 100 of priority 2 stop traveling, and the unmanned dump truck 2 of the unloaded state, the first unmanned light vehicle 1 of the normal state, and the second unmanned light vehicle 1 of the non-boarding state that are the unmanned vehicle 100 of priority 3 stop traveling.

Note that the input signal may designate the priority of the unmanned vehicle 100 to continue traveling and the priority of the unmanned vehicle 100 to stop traveling based on the second correlation data without using the first correlation data.

When the input signal includes a designation signal to designate priority, the decision unit 21 decides to continue or stop traveling for each of the plurality of unmanned vehicles 100 traveling in the work site 10 based on the second correlation data stored in the priority storage unit 19 and the input signal acquired by the input signal acquisition unit 20.

When the first input signal includes the designation signal to cause the unmanned vehicle 100 of priority 3 to stop traveling, based on the first input signal and the second correlation data, the decision unit 21 decides that the first unmanned light vehicle 1 of the emergency state and the third unmanned light vehicle 1 of the emergency state that are the unmanned vehicle 100 of priority 1 continue traveling, the unmanned dump truck 2 of the loaded state and the second unmanned light vehicle 1 of the boarding state that are the unmanned vehicle 100 of priority 2 continue traveling, and the unmanned dump truck 2 of the unloaded state, the first unmanned light vehicle 1 of the normal state, and the second unmanned light vehicle 1 of the non-boarding state that are the unmanned vehicle 100 of priority 3 stop traveling.

When the second input signal includes the designation signal to cause the unmanned vehicle 100 of priority 2 and priority 3 to stop traveling, based on the second input signal and the second correlation data, the decision unit 21 decides that the first unmanned light vehicle 1 of the emergency state and the third unmanned light vehicle 1 of the emergency state that are the unmanned vehicle 100 of priority 1 continue traveling, the unmanned dump truck 2 of the loaded state and the second unmanned light vehicle 1 of the boarding state that are the unmanned vehicle 100 of priority 2 stop traveling, and the unmanned dump truck 2 of the unloaded state, the first unmanned light vehicle 1 of the normal state, and the second unmanned light vehicle 1 of the non-boarding state that are the unmanned vehicle 100 of priority 3 stop traveling.

When the third input signal includes the designation signal to cause the unmanned vehicle 100 of priority 1, priority 2, and priority 3 to stop traveling, based on the third input signal and the second correlation data, the decision unit 21 decides that the first unmanned light vehicle 1 of the emergency state and the third unmanned light vehicle 1 of the emergency state that are the unmanned vehicle 100 of priority 1 stop traveling, the unmanned dump truck 2 of the loaded state and the second unmanned light vehicle 1 of the boarding state that are the unmanned vehicle 100 of priority 2 stop traveling, and the unmanned dump truck 2 of the unloaded state, the first unmanned light vehicle 1 of the normal state, and the second unmanned light vehicle 1 of the non-boarding state that are the unmanned vehicle 100 of priority 3 stop traveling.

The input signal may be generated by manipulating the first input device 15A, or may be generated based on the circumstance data indicating the circumstance of the work site 10. When generating the input signal based on the circumstance data, the administrator manipulates the second input device 15B to input the circumstance data including the type, scale, and location of occurrence of the accident that has occurred in the work site 10 into the management device 12. The circumstance data acquisition unit 23 acquires the circumstance data. The input signal generation unit 24 generates, for example, either one of the first input signal, the second input signal, and the third input signal based on the circumstance data. The input signal acquisition unit 20 acquires the input signal from the input signal generation unit 24. The decision unit 21 may decide to continue or stop traveling for each of the plurality of unmanned vehicles 100 travelling in the work site 10 based on the first correlation data and the second correlation data stored in the priority storage unit 19 and the input signal generated based on the circumstance data. Note that when the input signal includes the designation signal to designate priority, the decision unit 21 decides to continue or stop traveling for each of the plurality of unmanned vehicles 100 traveling in the work site 10 based on the second correlation data stored in the priority storage unit 19 and the input signal generated based on the circumstance data.

Management Method

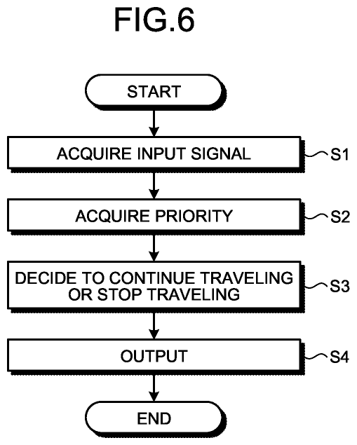

FIG. 6 is a flowchart illustrating a management method of the work site 10 according to the embodiment.

The input signal acquisition unit 20 acquires an input signal related to traveling stop of the unmanned vehicle 100. The input signal acquisition unit 20 may acquire the input signal from the first input device 15A or from the input signal generation unit 24 (step S1).

The decision unit 21 acquires the priority from the priority storage unit 19. In the embodiment, the priority storage unit 19 stores the first correlation data related to the priority as illustrated in FIG. 4 and the second correlation data related to the priority as illustrated in FIG. 5. The decision unit 21 acquires the first correlation data and the second correlation data from the priority storage unit 19. Note that when the input signal includes the designation signal to designate the priority, the decision unit 21 may acquire only the second correlation data from the priority storage unit 19 (step S2).

The decision unit 21 decides to continue traveling or stop traveling for each of the plurality of unmanned vehicles 100 traveling in the work site 10 based on the priority stored in the priority storage unit 19 and the input signal acquired by the input signal acquisition unit 20 (step S3).

The output unit 22 outputs the traveling stop command to the unmanned vehicle 100 for which traveling stop has been decided. The traveling stop command is transmitted to the unmanned vehicle 100 for which traveling stop has been decided via the communication system 13 (step S4).

The unmanned vehicle 100 that has received the traveling stop command stops traveling. Note that the determination unit 26 determines whether to stop traveling by the traveling stop command based on the circumstance of the unmanned vehicle 100. When the determination unit 26 determines not to stop traveling, the unmanned vehicle 100 continues traveling.

### Advantageous Effect

As described above, according to the embodiment, the management system 11 includes the priority storage unit 19 that stores the priority related to traveling continuation of the unmanned vehicle 100 travelling in the work site 10, the input signal acquisition unit 20 that acquires the input signal related to traveling stop of the unmanned vehicle 100, the decision unit 21 that decides to continue traveling or stop traveling for each of the plurality of unmanned vehicles 100 traveling in the work site 10 based on the priority and the input signal, and the output unit 22 that outputs the traveling stop command to the unmanned vehicle 100 for which traveling stop is decided. Accordingly, traveling stop and traveling continuation of the unmanned vehicle 100 are properly decided.

If an accident occurs in the work site 10, there are cases where it is preferable to cause all unmanned vehicles 100 to stop traveling, and there are cases where it is preferable to cause some unmanned vehicles 100 to continue traveling. Depending on the type, scale, and location of the accident, it may be preferable to allow the unmanned vehicle 100 travelling for urgent purposes to continue traveling. According to the embodiment, the priority related to the traveling continuation of the unmanned vehicle 100 is decided in advance. By designation of the priority by the input signal, traveling stop and traveling continuation of the unmanned vehicle 100 are properly decided.

### OTHER EMBODIMENTS

In the embodiment described above, at least part of functions of the controller 25 may be provided in the management device 12, or at least part of functions of the management device 12 may be provided in the controller 25. For example, in the embodiment described above, the management device 12 may have functions of the determination unit 26. For example, vehicle data indicating the circumstance of the unmanned vehicle 100 may be transmitted via the communication system 13 to the management device 12, and the management device 12 may determine whether to cause the unmanned vehicle 100 to stop traveling.

In the embodiment described above, the plurality of functions of the management device 12 may be configured by separate hardware. That is, each of the priority storage unit 19, the input signal acquisition unit 20, the decision unit 21, the output unit 22, the circumstance data acquisition unit 23, and the input signal generation unit 24 may be configured by separate hardware.

According to the present disclosure, traveling stop and traveling continuation of unmanned vehicles are properly decided.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A management system of a work site, the management system comprising:
a priority storage unit that stores priority related to traveling continuation of an unmanned vehicle traveling in the work site;
an input signal acquisition unit that acquires an input signal related to traveling stop of the unmanned vehicle;
a decision unit that decides the traveling continuation or the traveling stop for each of a plurality of the unmanned vehicles traveling in the work site based on the priority and the input signal; and
an output unit that outputs a traveling stop command to the unmanned vehicle for which the traveling stop is decided.

2. The management system of a work site according to claim 1, wherein
the priority designates the unmanned vehicle to continue traveling and the unmanned vehicle to stop traveling by the input signal, and
the decision unit decides to continue traveling or stop traveling for each of the plurality of unmanned vehicles traveling in the work site based on the priority.

3. The management system of a work site according to claim 2, wherein
the input signal includes a first input signal and a second input signal, and
the priority of the unmanned vehicle that stops traveling by the first input signal is different from the priority of the unmanned vehicle that stops traveling by the second input signal.

4. The management system of a work site according to claim 1, wherein
the input signal is generated by manipulation of an input device.

5. The management system of a work site according to claim 1, comprising:
a circumstance data acquisition unit that acquires circumstance data indicating circumstance of the work site; and
an input signal generation unit that generates the input signal based on the circumstance data.

6. The management system of a work site according to claim 1, wherein
the priority is decided based on at least one of a type and a state of the unmanned vehicle.

7. The management system of a work site according to claim 1,
comprising a determination unit that determines whether to stop traveling by the traveling stop command based on circumstance of the unmanned vehicle, wherein
when it is determined not to stop traveling, the unmanned vehicle continues traveling.

8. A management method of a work site, the management method comprising:
storing priority related to traveling continuation of an unmanned vehicle traveling in the work site;
acquiring an input signal related to traveling stop of the unmanned vehicle;
deciding the traveling continuation or the traveling stop for each of a plurality of the unmanned vehicles traveling in the work site based on the priority and the input signal; and
outputting a traveling stop command to the unmanned vehicle for which the traveling stop is decided.

9. The management method of a work site according to claim 8, wherein
the priority designates the unmanned vehicle to continue traveling and the unmanned vehicle to stop traveling by the input signal, and
the management method includes deciding to continue traveling or stop traveling for each of the plurality of unmanned vehicles traveling in the work site based on the priority.

10. The management method of a work site according to claim 9, wherein
the input signal includes a first input signal and a second input signal, and
the priority of the unmanned vehicle that stops traveling by the first input signal is different from the priority of the unmanned vehicle that stops traveling by the second input signal.

11. The management method of a work site according to claim 8, wherein
the input signal is generated by manipulation of an input device.

12. The management method of a work site according to claim 8, comprising
acquiring circumstance data indicating circumstance of the work site, wherein
the input signal is generated based on the circumstance data.

13. The management method of a work site according to claim 8, wherein
the priority is decided based on at least one of a type and a state of the unmanned vehicle.

14. The management method of a work site according to claim 8, comprising
determining whether to stop traveling by the traveling stop command based on the circumstance of the unmanned vehicle, wherein
when it is determined not to stop traveling, the unmanned vehicle continues traveling.
